(19) United States
(12) Patent Application Publication
(10) Pub. No.: US 2019/0287016 A1
(43) Pub. Date: Sep. 19, 2019

(54) COMPUTER-READABLE RECORDING MEDIUM, LEARNING METHOD, AND LEARNING DEVICE

(71) Applicant: FUJITSU LIMTED, Kawasaki-shi (JP)

(72) Inventors: TAKASHI KATOH, Kawasaki (JP); Kento Uemura, Kawasaki (JP); Toshio Endoh, Yokohama (JP); Suguru Yasutomi, Kawasaki (JP)

(73) Assignee: FUJITSU LIMITED, Kawasaki-shi (JP)

(21) Appl. No.: 16/295,850

(22) Filed: Mar. 7, 2019

(30) Foreign Application Priority Data
Mar. 13, 2018 (JP) 2018-045961

(51) Int. Cl. G06N 20/00

(52) U.S. Cl. CPC G06N 20/00

(57) ABSTRACT

A learning device has a characteristic generator to generate data of characteristic quantities by inputting test data, and training data to which labels are respectively given to a first learner; input the data of the characteristic quantities generated by the first learner to a second learner to output a result of estimation; and input the data of the characteristic quantities generated by the first learner to a third learner to output a result of classification of the training data and the test data. The second learner learns using the labels respectively given to the training data so that accuracy of the result of estimation with respect to the training data becomes higher. The third learner learns so that the training data and the test data are classified. The first learner learns so that accuracy of the result of estimation becomes higher and accuracy of the result of classification becomes lower.

### CROSS-REFERENCE TO RELATED APPLICATION

This application is based upon and claims the benefit of priority of the prior Japanese Patent Application No. 2018-045961, filed on Mar. 13, 2018, the entire contents of which are incorporated herein by reference.

### FIELD

The embodiments discussed herein. are related to a computer-readable recording medium, a learning method, and a learning device.

### BACKGROUND

When performing classification and regression by means of machine learning, the learning is generally performed by using training data prepared in advance to estimate test data to be estimated. The learning is, for example, performed by using training data including a pair of a hand printed character and a character type to estimate a label of another hand printed character. Furthermore, the learning is performed by using training data including a pair of an input to a simulator and a result for the input to estimate a result for another input, such as an actual observed value. See Japanese Laid-open Patent Publication No. 2016-133895, Japanese Laid-open Patent Publication No. 2014-228972, Japanese Laid-open Patent Publication No. 2016-224821, and Japanese Laid-open Patent Publication No. 2011-243147).

However, when the characteristics of the training data and the test data differ from each other, there may be a case that the accuracy of the estimation result is deteriorated. For example, when the test data of the hand printed characters differ in contrast, shadow, noise, or the like due to environments from each other, or when data nonexistent in the input of the simulation of the training data exist in the actual observed value, the accuracy of the estimation result is deteriorated.

As a countermeasure for this problem, the following process is performed; that is, the training data is compared with the test data, and when difference exists between. the training data and the test data, the data are processed so as to make the difference smaller before learning. However, since there are various kinds of differences of data due to the types and the states of the data, a process method to be used is not always a process method used in a well-known field. Furthermore, it is impossible to determine whether the process method is appropriate unless the test data is actually applied to the learning.

### SUMMARY

According to an. aspect of an embodiment, a non-transitory computer-readable recording medium stores therein a program that causes a computer to execute a process. The process includes generating data of characteristic quantities by inputting test data, and training data to which labels are respectively given to a first learner; first inputting the data of the characteristic quantities generated by the first learner to a second learner to output a result of estimation; and second inputting the data of the characteristic quantities generated by the first learner to a third learner to output a result of classification of the training data and the test data, wherein the first inputting includes learning the second learner using the labels respectively given to the training data so that an accuracy of the result of estimation with respect to the training data becomes higher, the second inputting includes learning the third learner so that the training data and the test data are classified, and the generating includes learning the first learner so that the accuracy of the result of estimation becomes higher and an accuracy of the result of classification becomes lower.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining a learning device according to a first embodiment;

FIG. 2 is a view for explaining a process method of general preprocessing;

FIG. 3 is a view illustrating the distribution of characteristic quantities when the preprocessing of test data is omitted;

FIG. 4 is a functional block diagram illustrating the function configuration of the learning device according to the first embodiment;

FIG. 5 is a view for explaining the learning transition of the learning device according to the first embodiment;

FIG. 6 is a view for explaining improvements in learning accuracy;

FIG. 7 is a flowchart illustrating the flow of learning processing; and

FIG. 8 is a view illustrating a hardware configuration example.

### DESCRIPTION OF EMBODIMENTS

Preferred embodiments will be explained with reference to accompanying drawings. Here, the present invention is not limited to these embodiments. The embodiments can be properly combined with each other without departing from the gist of the present invention.

[a] First Embodiment

Explanation of the learning device

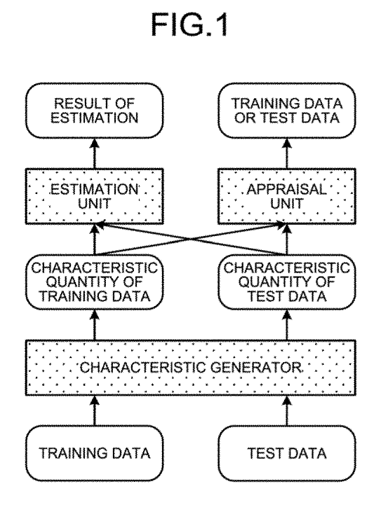

FIG. 1 is a view for explaining the learning device according to the first embodiment. The learning device illustrated in FIG. 1 is a computer device such as a server or a personal computer, and has three learners: a characteristic generator, an estimation unit (estimator), and an appraisal unit. Each of the learners is capable of using a differentiable model such as a neural network, and capable of adopting various learning techniques such as a gradient method or random search method.

The learning device illustrated in FIG. 1 uses these learners to reduce the failure of estimation due to the difference between training data and test data. To be more specific, the characteristic generator learns so that the accuracy of the estimation unit becomes higher and the accuracy of the appraisal unit becomes lower. The estimation unit learns so that the accuracy of the estimation result with respect to the training data becomes higher. The appraisal unit learns so that classification into the training data and the test data is able to be made.

Here, the countermeasure for resolution of the difference between the training data and the test data by a general method is explained. In general, an administrator or the like compares the training data with the test data and when the difference between the training data and the test data exists, the administrator or the like manually processes the data so as to make the difference smaller before learning.

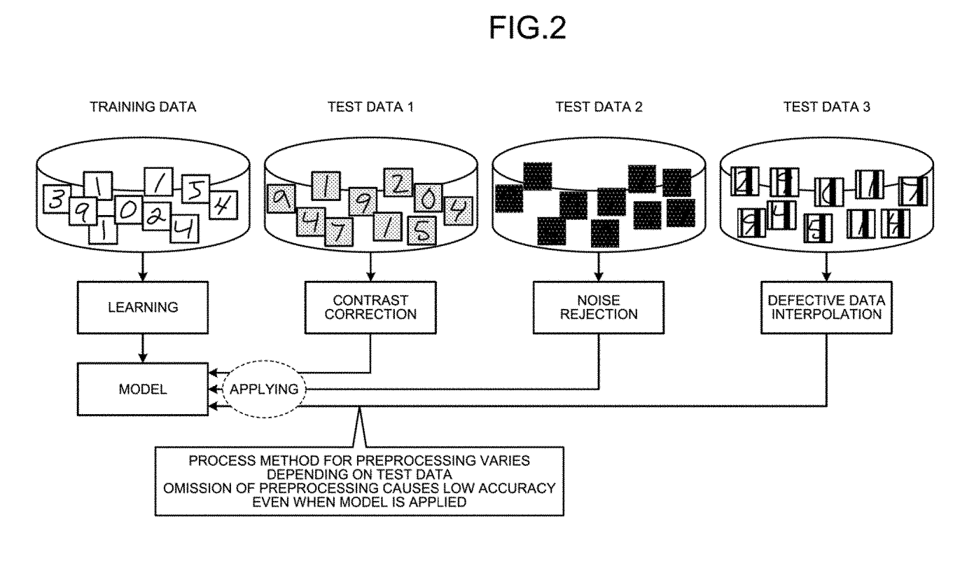

FIG. 2 is a view for explaining a process method of general preprocessing. As illustrated in FIG. 2, as compared with the training data, test data 1 is different in contrast, test data 2 has noise, and test data 3 is defective data. In this case, the administrator performs preprocessing with respect to these test data to supply the test data to a model (learner). To be more specific, contrast correction processing is performed with respect to the test data 1, noise rejection processing is performed with respect to the test data 2, and defective data interpolation processing is performed with respect to the test data 3.

In this manner, although various kinds of differences in the test data exist depending on the types and states of the data, a process method to be used is not always the process method that is simply determined as illustrated in FIG. 2. When the process method to be used is not determined, a trial-and-error process is performed by the administrator thus taking a lot of time cost and man-power cost. Accordingly, in order to reduce the costs, it is conceivable that the preprocessing with respect to the test data is omitted. However, when the preprocessing is omitted, the learning accuracy with respect to the test data is deteriorated.

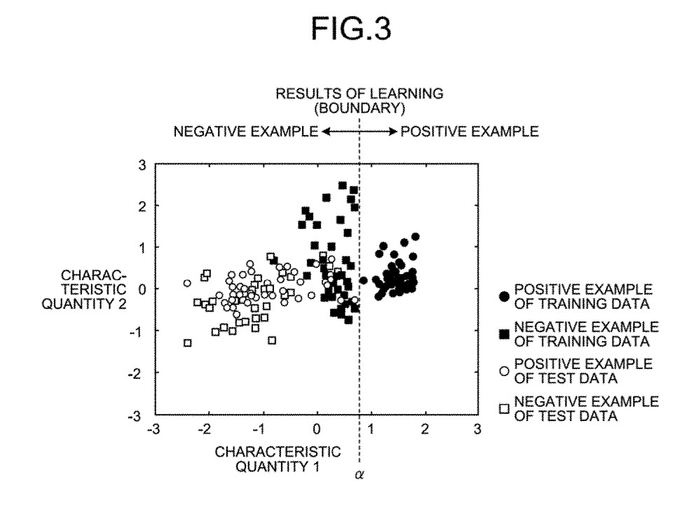

FIG. 3 is a view illustrating the distribution of characteristic quantities when the preprocessing of test data is omitted. FIG. 3 illustrates the characteristic quantities in two dimensions, and the explanation is made by taking a linear learner as an example, the linear learner being configured to separate the characteristic quantities into a positive example (+) and a negative example (−) by setting a straight line as a boundary. As illustrated in FIG. 3, the description will be made assuming that as a result of learning by using the training data, a straight line a that separates the positive example (+) and the negative example (−) is obtained. When the test data having characteristics different from the training data is applied to such a learning device, as illustrated in FIG. 3, there may be a case that both the positive example and the negative example of the test data are classified into a negative example side of the straight line α. That is, the test data and the training data are different from each other in the distribution of the characteristic quantities used for discrimination or regression and hence, a model (learning model) obtained by learning with the use of the training data is erroneously conformed to the training data. What is called an extrapolation drawback occurs.

In this manner, even when the result of learning using the training data is applied to the test data, the result of learning using the data having different characteristics brings about the poor classification accuracy of the test data. Consequently, when the preprocessing is omitted for reducing costs, the costs can be reduced and in contrast, learning accuracy is deteriorated. On the other hand, when the preprocessing is performed after repeating the trial and error of the process method, it is expected that deterioration in learning accuracy can be suppressed to some extent and in contrast, the costs increase. That is, the costs and the learning accuracy are in a trade-off relation and hence, it is difficult to artificially solve the problems above.

Accordingly, in machine learning, the learning device according to the first embodiment suppresses the failure of estimation that occurs due to the difference between the training data and the test data without taking time and efforts that are requested to perform manually the preprocessing for absorbing the difference. To be more specific, the learning device automatically generates the characteristic quantity common to the training data and the test data, and uses the characteristic quantity for learning. The learning device determines whether the characteristic quantity to be used is the characteristic quantity common to the training data and the test data with the use of a classifier (appraisal unit) that classifies the training data and the test data based on the respective characteristic quantities. Furthermore, the learning device simultaneously uses the learner that determines the difference between the training data and the test data, and performs the intended learning using the characteristic quantity that the learner is not able to determine. In this manner, the learning device simultaneously achieves the simplification of the preprocessing of data, and reduction of the man-power cost or the like.

Function configuration of learning device

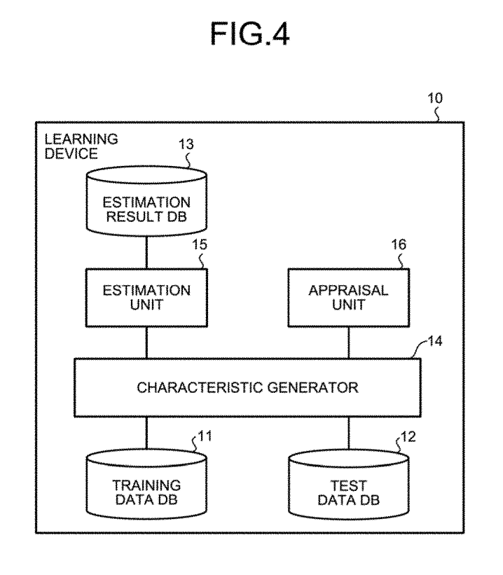

FIG. 4 is a functional block diagram illustrating the functional configuration of a learning device 10 according to the first embodiment. As illustrated in FIG. 4, the learning device 10 has a training data DB 11, a test data DB 12, an estimation result DB 13, a characteristic generator 14, an estimation unit 15, and an appraisal unit 16. Here, the training data DB 11, the test data DB 12, and the estimation result DB 13 are stored in a memory, a hard disk, or the like. The characteristic generator 14, the estimation unit 15, and the appraisal unit 16 are also achievable by a process executed by a processor or the like.

The training data DB 11 is a database that stores the training data to be learned, a label being given to the training data. To be more specific, the training data DB 11 stores a plurality of data groups as the training data, each of the data groups being constituted. such that “an input and a label (y)” are associated with. each other.

The test data DB 12 is a database that stores the test data to be estimated, a label being not given to the test data. To be more specific, the test data DB 12 is a database that stores at least one “input (x′)” the label of which is unknown.

The estimation result DB 13 is a database that stores results of estimation performed by the estimation unit 15 described later. For example, the estimation result DB 13 stores a label (y′) that is a result of estimation when the input (x) is input to the estimation unit 15.

The characteristic generator 14 is a learner that learns using the training data and the test data, the characteristic generator 14 being configured to learn so as to generate the characteristic quantity from various types of data, and generate the characteristic quantity common to the training data and the test data. Here, as one example of the characteristic quantity, when a learning object is an image, an edge and contrast in the image, the positions of eyes and a nose in the image, or the like are named.

For example, the characteristic generator 14 generates a characteristic quantity (z) of the training data (x, y) stored in the training data DB 11 to output the characteristic quantity (z) to the estimation unit 15 and the appraisal unit 16. The characteristic generator 14 generates a characteristic quantity (z′) of the test data (x) stored in the test data DB 12 to output the characteristic quantity (z′) to the estimation unit 15 and the appraisal unit 16. Furthermore, the characteristic generator 14 learns using the training data and the test data so that the accuracy of the estimation unit 15 described later becomes higher and the accuracy of the appraisal unit 16 becomes lower. In this time, the characteristic generator 14 is capable of using the error gradients of the appraisal unit 16 and the estimation unit 15 with respect to the characteristic quantities.

The estimation unit 15 is a learner that learns using the training data, the estimation unit 15 being configured to learn classification and regression from the characteristic quantities. For example, the estimation unit 15 uses the characteristic quantity (z) of the training data (x, y) and the characteristic quantity (z′) of the test data (a) to estimate the label (y′) when the input (a) of the training data (input (a), label (y)) is input to estimation unit 15, and store the label (y′) in the estimation result DB 13. Furthermore, the estimation unit 15 learns so that the error of the result of estimation of the label (y′) with respect to the label (y) that is known becomes small. That is, the estimation unit 15 learns so that the label (y) can accurately be restored from the input (x).

The appraisal unit 16 is a learner that learns using the training data and the test data, the appraisal unit 16 being configured to learn so that classification into the training data and the test data is able to be made. To be more specific, the appraisal unit 16 determines whether the characteristic quantity that the estimation unit 15 uses the characteristic quantity common to the training data and the test data by classifying the training data and the test data based on the respective characteristic quantities. For example, the appraisal unit 16 accepts the characteristic quantity (z) of the training data (x, y) and the characteristic quantity (z′) of the test data (x), and detects the difference between the respective characteristic quantities based on, for example, the similarity between the characteristic quantity (z) and the characteristic quantity (z′). Furthermore, the learning of the characteristic quantity is performed so that the detection accuracy of the difference between the respective characteristic quantities in the appraisal unit 16 is deteriorated. That is, the learning of the characteristic quantity is performed so that the appraisal unit 16 is incapable of performing accurate classification into the characteristic quantity of the training data and the characteristic quantity of the test data.

Here, when each of the characteristic generator 14, the estimation unit 15, and the appraisal unit 16 has limitation in learning time due to a real-time operation or the like, the learning processing using the training data and the test data is repeatedly performed for a predetermined number of times. Furthermore, when each of the characteristic generator 14, the estimation unit 15, and the appraisal unit 16 has no limitation in learning time, the learning processing is repeatedly performed until the accuracy of the estimation unit 15 is improved and the classification accuracy of the appraisal unit 16 is sufficiently lowered.

For example, the learning processing is repeatedly performed. until the result of estimation performed by the estimation unit 15 becomes equal to or greater than a reference value. To be more specific, the learning processing is repeatedly performed until the error of the result of estimation of the label (y′) with respect to the label (y) that is known becomes equal to or lower than a threshold value, or the learning processing is repeatedly performed until the number of times where the label (y′) and the label coincide with each other or the number of times where the error becomes equal to or lower than the threshold value becomes equal to or greater than a prescribed number of times.

Furthermore, the learning processing is repeatedly performed until the classification accuracy of the appraisal unit 16 becomes lower than a reference value. To be more specific, the learning processing using the training data and the test data is repeatedly performed until the similarity between the characteristic quantity (z) and the characteristic quantity (z′) becomes equal to or lower than a threshold value, the similarity being calculated by the appraisal unit 16. Each of the training data and the test data can also be changed for every time the learning processing is performed without using repeatedly the same data.

Learning transition

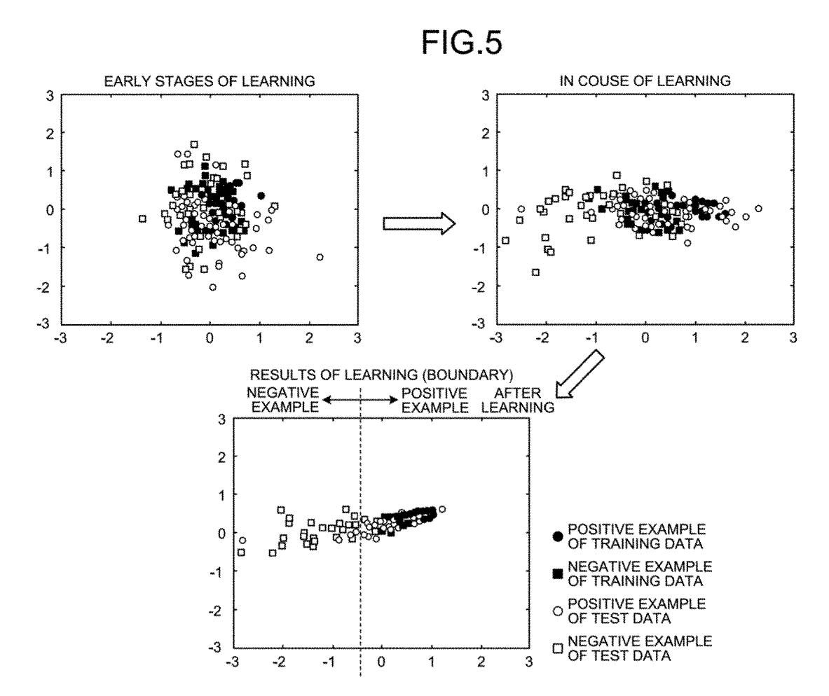

FIG. 5 is a view for explaining the learning transition of the learning device according to the first embodiment. FIG. 5 illustrates, in the same manner as FIG. 3, the characteristic quantities in two dimensions, and the explanation is made by taking the linear learner as an example, the linear learner being configured to separate the characteristic quantities into a positive example (+) and a negative example (−) by setting a straight line as a boundary.

As illustrated in FIG. 5, in early stages of learning, the characteristic generator 14 starts learning so as to generate the characteristic quantity common to the training data and the test data and hence, the characteristic quantity of the training data and the characteristic quantity of the test data are independently generated. Consequently, neither the training data nor the test data is classified into a positive example and a negative example.

Furthermore, in the course of learning, the characteristic generator 14 performs learning so as to generate the characteristic quantity common to the training data and the test data and hence, a characteristic quantity similar to the characteristic quantity common to the training data and the test data is being generated. Consequently, both the training data and the test data are gradually classified into the positive example and the negative example.

When the learning processing is thereafter finished, the characteristic generator 14 is capable of generating the characteristic quantity common to the training data and the test data and hence, the characteristic quantity common to the training data and the test data is generated. Consequently, as compared with FIG. 3, the distributions of the respective characteristic quantities of the training data and the test data are closer to each other than before, and both the training data and the test data can be classified into the positive examples and the negative examples with sufficient accuracy. Accordingly, the learning device 10 is capable of learning a classification boundary position (straight line).

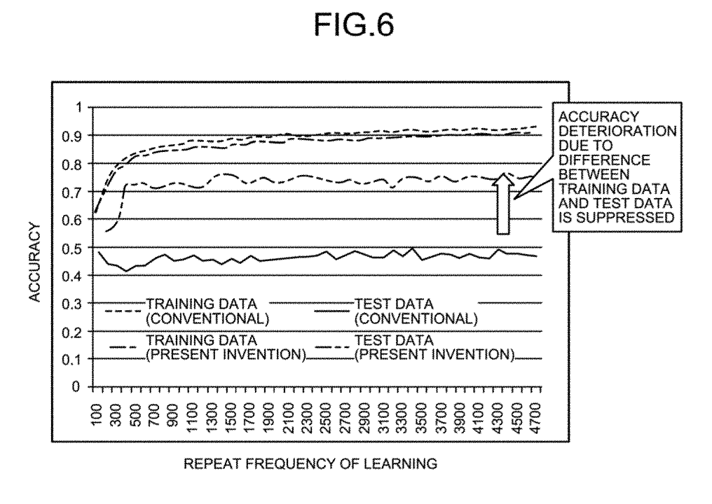

FIG. 6 is a view for explaining improvements in learning accuracy. Here, although the preprocessing is requested because the characteristics of the training data and the test data are different from each other, the explanation is made assuming that the preprocessing for the test data is not performed. Furthermore, the explanation is made by taking the linear learner as an example, the linear learner being configured to separate characteristics quantities into a positive example (+) and a negative example (−) by setting a straight line as a boundary.

As illustrated in FIG. 6, as for the learning accuracy with respect to the training data, there exists no large difference between the case where the method according to the first embodiment is used and the case where the general method (conventional method) is used. Here, the learning device according to the first embodiment does not generate the simple characteristic quantity of the training data but generates the characteristic quantity common to the training data and the test data thus lowering slightly the learning accuracy as compared with the conventional method. However, there exists little influence on the learning accuracy.

On the other hand, in the case of the test data, the conventional method uses the test data different in characteristics from the training data thus lowering the classification accuracy even when the result of learning of the training data is used as it is, and the learning accuracy is not improved even when a learning frequency 1S increased. In contrast, in the method according to the first embodiment, the characteristic quantity is learned so that the classification accuracy in the appraisal unit 16 is deteriorated along with the increase of the learning frequency thus generating the characteristic quantity common to the training data and the test data. Consequently, the learning is performed using the training data and the test data thus improving gradually the classification accuracy even when using the test data different in characteristics from the training data. That is, the accuracy deterioration due to the difference between the training data and the test data is suppressed.

Processing flow

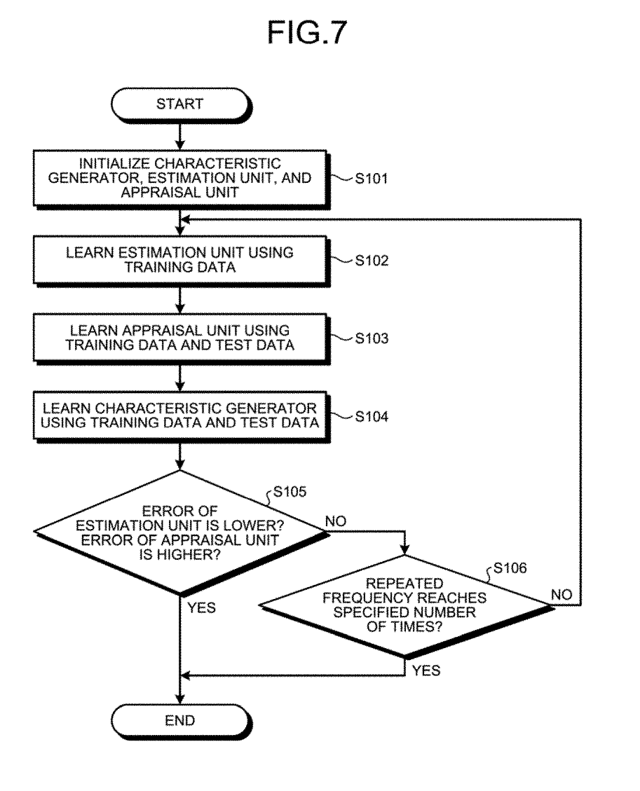

FIG. 7 is a flowchart illustrating the flow of the learning processing. As illustrated in FIG. 7, the learning device 10 initializes the characteristic generator 14, the estimation unit 15, and the appraisal unit 16 (S101). Here, the learning device 10 initializes using a general initialization method of well-known learning processing.

Subsequently, the learning device 10 learns the estimation unit 15 using the training data (S102), and learns the appraisal unit 16 using the training data and the test data (S103). Furthermore, the learning device 10 learns the characteristic generator 14 using the training data and the test data (S104).

Thereafter, the learning device 10 terminates the processing when the error of the estimation unit 15 is reduced and the error of the appraisal unit 16 is increased. (Yes at S105). For example, when the error of the estimation unit 15 is equal to or less than a first threshold value and the error of the appraisal unit 16 is equal to or greater than a second threshold value, the learning device 10 terminates the learning processing, and performs the classification of the test data using the results of learning. Here, each of the threshold values can optionally be set.

On the other hand, when the error of the estimation unit 15 is increased and the error of the appraisal unit 16 is reduced (No at S105), the learning device 10 determines whether the repeat frequency of the learning processing reaches the specified number of times (S106). Here, the learning device 10 terminates the learning processing when the repeat frequency of the learning processing reaches the specified number of times (Yes at S106), and. repeats the learning processing starting from S102 when the repeat frequency of the learning processing does riot reach the specified number of times (No at S106).

Advantageous effect

As mentioned above, the learning device 10 learns the appraisal unit 16 that determines the difference between the training data and the test data, and performs intended learning using the characteristic quantity that the appraisal unit 16 is not able to determine. Consequently, the learning device 10 is capable of learning accurately while solving what is called an extrapolation drawback. The learning device 10 is capable of suppressing the failure of estimation due to the difference between the training data and the test data with respect to a decision problem and a regression problem using the neural network. Furthermore, the learning device 10 is capable of improving the learning accuracy while omitting the preprocessing performed by the administrator or the like even when the types or the like of the training data and the test data are different from each. other thus achieving both the simplification of the preprocessing, and reduction of man-power cost or the like.

[b] Second embodiment

Although the embodiment of the present invention is explained heretofore, the present invention may be performed with various different constitutions in addition to the above-mentioned embodiment. Hereinafter, another embodiment is explained.

Error display

The learning device 10 may also include a display controller that exhibits the accuracy of the estimation unit 15 and the appraisal unit 16 to provide the information based on which the validity of processing is determined. For example, the display controller of the learning device 10 allows the results of classification of the training data or the test data by the appraisal unit 16, the difference between respective characteristic quantities, the similarity of the respective characteristic quantities, the result of estimation by the estimation unit 15, the plot of the learning transition illustrated in FIG. 5, and the like, to be displayed on a display and transmitted to an administrator terminal. As a result, the administrator verifies the accuracy of the appraisal unit 16 thus estimating the influence of the extrapolation drawback. The above-described information can be displayed each time the learning processing is performed, or for every several times of the learning processing.

System

The processing procedures, the control procedures, the specific names, and the information including various types of data and parameters that are mentioned above or illustrated in the drawings can optionally be changed unless otherwise specified. Here, each of the estimation unit 15, the appraisal unit 16, the characteristic generator 14, and the display controller is one example of an estimation unit, an appraisal unit, a characteristic generator, or a display controller, respectively. Furthermore, each of the threshold values and the reference values can optionally be changed.

The constitutional features above are conceptually illustrated in the drawings, and are not requested to be physically constituted as illustrated in the drawings. The specific form of distribution and integration of the respective constitutional features is not limited to the examples illustrated in the drawings. That is, all or a part of the constitutional features can be functionally or physically constituted in a distributed or integrated manner in any desired units depending on various kinds of loads, use conditions, or the like. Furthermore, all or a part of processing functions performed in each of the devices can be achieved by a CPU and a computer program analyzed and performed by the CPU, or can be achieved as hardware constituted by a wired logic.

Hardware configuration

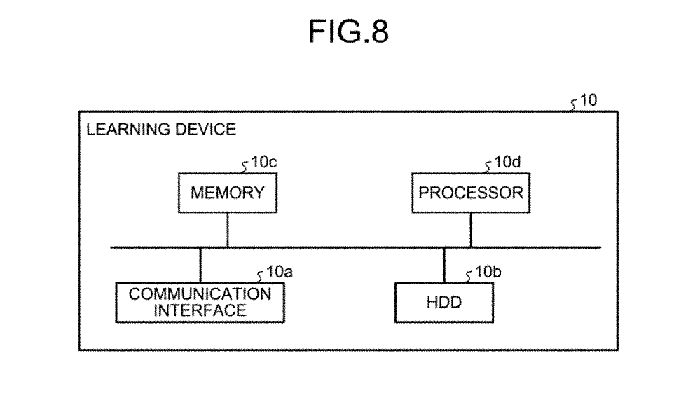

FIG. 8 is a view illustrating a hardware configuration example. As illustrated in FIG. 8, the learning device 10 has a communication interface 10a, a hard disk drive (HDD) 10b, a memory 10c, and a processor 10d.

The communication interface 10a is a network interface card or the like that controls communication with other devices. The HDD 10b is one example of a storage device that stores programs, data, or the like.

As one example of the memory 10c, a random access memory (RAM) such as a synchronous dynamic random access memory (SDRAM), a read only memory (ROM), a flash memory, and the like are named. As one example of the processor 10d, a central processing unit (CPU), a digital signal processor (DSP), a field programmable gate array (FPGA), a programmable logic device (PLD), and the like are named.

The learning device 10 is also operated as an information processing unit that performs learning processing by reading and executing the programs. That is, the learning device 10 runs the program that executes respective functions identical with the characteristic generator 14, the estimation unit 15, and the appraisal unit 16. As a result, the learning device 10 is capable of performing the process that executes the respective functions identical with the characteristic generator 14, the estimation unit 15, and the appraisal unit 16. Here, the program to be used in the embodiments is not always performed by the learning device 10. For example, the present invention can also be applied to the case where another computer or server executes the program, or the computer and the server execute the program in cooperation with each other.

The program can be distributed via a network, such as the Internet. Furthermore, the program is stored in a recording medium readable by a computer, such as a hard disk, a flexible disk (FD), a CD-ROM, a magneto-optical disk (MO), or a digital versatile disc (DVD), and is read out from the recording medium by a computer to be executed.

According to the embodiments, it is possible to suppress the precision deterioration of the estimation result.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples is the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
generating data of characteristic quantities by inputting test data, and training data to which labels are respectively given to a first learner;
first inputting the data of the characteristic quantities generated by the first learner to a second learner to output a result of estimation; and
second inputting the data of the characteristic quantities generated by the first learner to a third learner to output a result of classification of the training data and the test data, wherein
the first inputting includes learning the second learner using the labels respectively given to the training data so that an accuracy of the result of estimation with respect to the training data becomes higher,
the second inputting includes learning the third learner so that the training data and the test data are classified, and
the generating includes learning the first learner so that the accuracy of the result of estimation becomes higher and an accuracy of the result of classification becomes lower.

2. The non-transitory computer-readable recording medium having stored therein a program according to claim 1, wherein the process further comprises:
performing repeatedly learning processing of each of the second learner, the third learner, and the first learner for a predetermined number of times when there is a limitation in learning time, and to perform repeatedly, when there is no limitation in learning time, the learning processing until the accuracy of the second learner becomes higher than a reference value and the classification accuracy of the third learner becomes lower than a reference value.

3. The non-transitory computer-readable recording medium having stored therein a program according to claim 2, wherein the process further comprises:
displaying the result of estimation performed by the second learner, or the result of classification performed by the third learner each time learning processing is performed within the learning time, or for every specified number of times of the learning processing.

4. A learning method comprising:
generating data of characteristic quantities by inputting test data, and training data to which labels are respectively given to a first learner, using a processor;
first inputting the data of the characteristic quantities generated by the first learner to a second learner to output a result of estimation, using the processor; and
second inputting the data of the characteristic quantities generated by the first learner to a third learner to output a result of classification of the training data and the test data, using the processor, wherein
the first inputting includes learning the second learner using the labels respectively given to the training data so that an accuracy of the result of estimation with respect to the training data becomes higher,
the second inputting includes learning the third learner so that the training data and the test data are classified, and
the generating includes learning the first learner so that the accuracy of the result of estimation becomes higher and an accuracy of the result of classification becomes lower.

5. A learning device comprising:
a memory; and
a processor coupled to the memory and the processor configured to:
generate data of characteristic quantities by inputting test data, and training data to which labels are respectively given to a first learner;
input the data of the characteristic quantities generated by the first learner to a second learner to output a result of estimation; and
input the data of the characteristic quantities generated by the first learner to a third learner to output a result of classification of the training data and the test data,
wherein. the processor is further configured to, learn the second learner using the labels respectively given to the training data so that an accuracy of the result of estimation with respect to the training data becomes higher,
learn the third learner so that the training data and the test data are classified, and
learn the first learner so that the accuracy of the result of estimation becomes higher and an accuracy of the result of classification becomes lower.
